(19) United States
(12) Patent Application Publication
(10) Pub. No.: US 2013/0233699 A1
(43) Pub. Date: Sep. 12, 2013

(54) Device and Method for Plasma-Based Structure Manipulation of Hydrocarbons and Other Substances

(71) Applicant: Walter Allan Brown, Panama City Beach, FL (US)

(72) Inventor: Walter Allan Brown, Panama City Beach, FL (US)

(21) Appl. No.: 13/416,403

(22) Filed: Mar. 9, 2012

(51) Int. Cl. B01J 19/08

(52) U.S. Cl. 204/157.15

(57) ABSTRACT

An apparatus and method for the manipulation of selected substances—such as long chain hydrocarbons—in order to create resulting substances having shorter chain lengths. The method also produces heat and electricity as byproducts. Significantly, the chain length reduction is accomplished without an oxidation-reduction reaction such as found in combustion. Thus, no significant amount of greenhouse gasses are produced. A hydrocarbon-containing fuel is converted into a plasma within an accelerator chamber. The plasma interacts with one or more target systems which intrude upon the flow. Electron removal devices are used to remove free electrons from the plasma, after which the fuel is decelerated and cooled. The cooled fuel contains altered molecules due to the removal of the free electrons.

### CROSS-REFERENCES TO RELATED APPLICATIONS

Not Applicable.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of energy. More specifically, the invention comprises a method and apparatus for modifying the structure of substances such as hydrocarbon fuels in order to convert low-value fuels into high-value fuels and other useful byproducts. The structural modification may also be employed to convert dangerous or undesirable substances into more desirable substances.

2. Description of the Related Art

The present invention will most often be employed for the production of desirable combustion fuels, and the background will accordingly be discussed with respect to this field of application. Fuels used for energy production are most commonly used as a gas, a liquid, or a finely-particulated solid. Combustion processes for such materials are well-understood and may be well regulated with suitable equipment. Of course, long-chain hydrocarbon fuels are not normally found in this state. The most common fuels include hydrocarbon chains of varying lengths, with coal being a good example.

Fuels containing long-chain hydrocarbons must be significantly processed before they may be efficiently used. A common application is the processing of coal into a particulated fuel that is suitable for combustion in a large and stationary power plant. Long-chain hydrocarbon-containing solids are an abundant energy source, and it is desirable to use such fuels in areas beyond electric power plants. As an example, it is desirable to make such a fuel source available for motor vehicles. Unfortunately, the transport and handling of a particulated solid is impractical for use in vehicles.

Coal contains a substantial mass fraction of impurities and a substantial variation in the molecular chain length of the hydrocarbons it contains. These factors require the use of significant “scrubbing” technology (such as required to remove sulfur compounds and carbon dioxide from the exhaust products). The equipment required for scrubbing is complex and heavy, making it undesirable for a vehicle.

On the other hand, some hydrocarbons can be stored as a gas or liquid. Methane and propane are good examples of hydrocarbons which can be stored as either a gas or a liquid. Both these compounds have been established as suitable fuels for a motor vehicle. It is even possible to use such hydrocarbons as an energy source without combustion (such as via the use of a fuel cell).

Some shorter chain hydrocarbons may only be practically stored as a liquid (light oils), but even these are useful in the field of transportation. It is therefore desirable to provide an apparatus which can convert the long hydrocarbon chains found in low-value fuels to short hydrocarbon chains such as found in methane, propane, or light oils. Such a conversion has traditionally been performed by a “cracking” process (where the term “cracking” refers to breaking some of the carbon-carbon bonds in a long-chain hydrocarbon to form shorter chains). Traditional cracking requires the addition of a substantial amount of heat and produces many unwanted byproducts. Thus, it is desirable to achieve the end result of a traditional cracking process while reducing the amount of energy required and reducing the production of unwanted byproducts such as carbon dioxide. The present invention proposes such a device.

### BRIEF SUMMARY OF THE INVENTION

The present invention comprises an apparatus and method for the manipulation of selected substances—such as long chain hydrocarbons—to generate more desirable substances having shorter chain lengths. The method also produces heat and electricity as desirable byproducts. Significantly, the chain length reduction is accomplished without an oxidation-reduction reaction such as found in combustion. Thus, no significant amounts of greenhouse gasses are produced.

A fuel stock with additives is prepared by scrubbing and sizing to produce a suitable particle size distribution and overall viscosity. The prepared fuel stock is then injected into a first stage of an accelerator chamber—where it is subjected to high energy electrical pulses or arc furnace. The preparation, injection, heating, acceleration, and recovery of the products are all performed in the absence of oxygen or other oxidizers (other than those which may be released by the fuel itself).

The accelerator chamber is operated at high pressure. The fuel injector feeds the fuel into the first stage of the accelerator chamber without allowing any backflow and without allowing oxygen contamination. In the first stage of the accelerator chamber, the fuel is subjected to variable frequency electrical pulses (an arc furnace). The arc furnace converts the fuel into a gaseous form.

The gaseous fuel leaves the first stage and accelerates through the accelerator chamber. It is next subjected to microwave (or higher frequency) electromagnetic energy. The microwave energy breaks the long chain hydrocarbon bonds, liberating the bond energy. This liberated energy heats and accelerates the gaseous fuel stream to a velocity sufficient to form a plasma.

The fuel stream then enters a constricting throat area which will further accelerate the stream. At least one stationary target is provided in the throat area. The rapidly flowing plasma reacts with this target. At this point the plasma contains sufficient hydrogen ions and free electrons to be conductive. Just prior to reacting with the target, the fuel stream is aligned or polarized by passing additional microwave energy through the plasma. An electron removal circuit is connected to the target, or possibly to conductive probes in the vicinity of the target. This circuit removes a significant portion of the free electrons found in the flowing plasma.

Downstream from the target, a magnetohydrodynamic generator (MHG) is preferably employed to harvest more of the remaining free electrons. Prior to the flow entering the MHG, an additional microwave generator may be used to align the plasma with the poles of the MHG.

The electrons removed from the fast moving plasma may be used to provide power to electrical devices. Waste heat may also be harvested from the accelerator chamber, since the chamber must be cooled to maintain continuous operation. The heat removed may be used to drive a turbine or other waste heat recovery device.

Exiting the target and the magnetohydrodynamic generator, the contents will be decelerated and cooled (still in the absence of oxygen). The removal of the free electrons while the contents are in the plasma state modifies the reformation of longer hydrocarbon chains upon cooling. Thus, the cooled and decelerated fuel stream will contain modified substances such as shorter hydrocarbon chains than the substance or substances that entered the process. The cooled and decelerated gas preferably undergoes a separation and refining process to extract desired solids, liquids, and gasses.

### BRIEF DESCRIPTION OF THE SEVERAL VIEWS OF THE DRAWINGS

FIG. 1 is a schematic view, showing the present inventive process.

FIG. 2 is an elevation view, showing the bending path of a plasma flow into an electron-harvesting target.

FIG. 3 is an elevation view, showing the accelerator chamber and the components surrounding it.

FIG. 4 is a detailed elevation view, showing the target.

REFERENCE NUMERALS IN THE DRAWINGS

| | | | |
|---|---|---|---|
| 10 | chain reduction process | 12 | fuel stock and additives |
| 14 | fuel preparation | 16 | fuel injector |
| 18 | accelerator chamber | 20 | target system |
| 22 | electron removal circuit | 24 | heat and velocity reduction |
| 26 | refinery | 28 | plasma flow |
| 30 | arc furnace | 34 | microwave generator |
| 36 | throat | 38 | microwave generator |
| 40 | MHG | | |

### DETAILED DESCRIPTION OF THE INVENTION

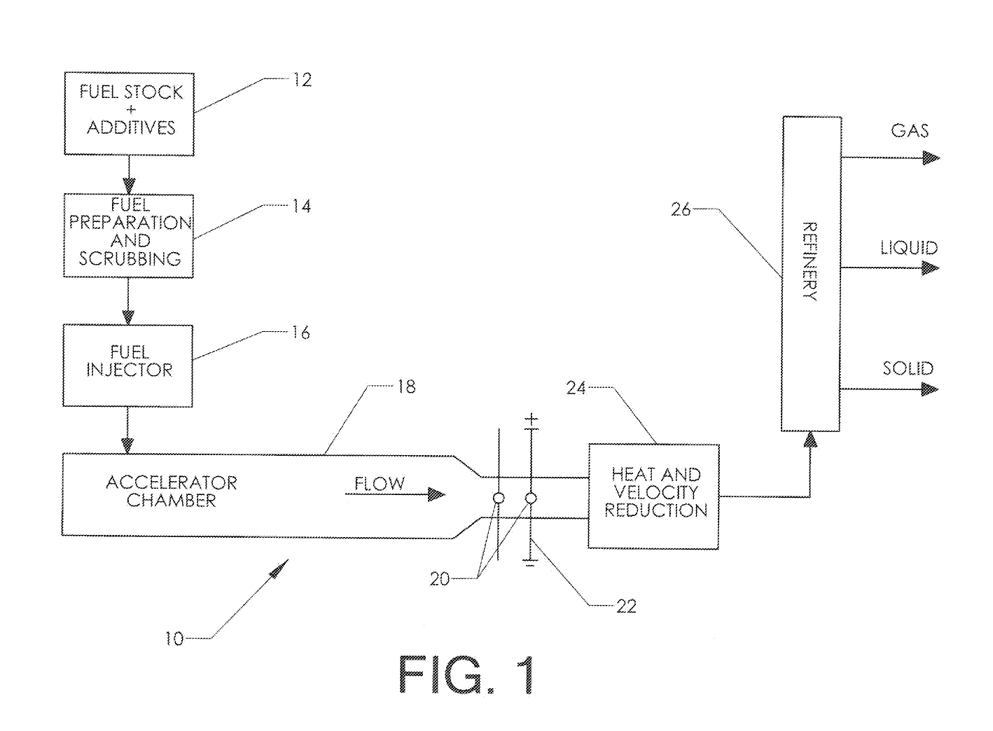

FIG. 1 schematically depicts the inventive process in its entirety (chain reduction process 10). Fuel stock and additives 12 are prepared (in step 14) by physically manipulating the stock to the correct size (in the case of a solid or viscosity (in the case of a liquid). Additives are preferably blended into the stock to alter the process or the end-products. It is important to reduce the amount of oxidizers in the fuel stock in order to minimize combustion phenomena. Thus, a scrubbing process may be employed to eliminate unwanted constituents (fuel preparation step 14).

Once the fuel is suitably prepared it is fed into fuel injector 16. The injector must deliver the fuel mixture into accelerator chamber 18 under pressure (generally a pressure greater than that within the accelerator chamber). However, the injector preferably does not allow unwanted oxidizers (typically air) to enter the accelerator chamber, nor does it allow any backflow. In order to accomplish this objective, it may be necessary to employ a suitable gas—such, as argon—as a shield during the injection process.

Numerous approaches are available to achieve the desired injection. One approach would be to use a mechanical feeding mechanism (such as a screw auger or positive displacement pump) to force the fuel into the pressurized accelerator chamber. Another approach would be to simply load all the required and prepared fuel into a separate pressurized chamber which is then pressurized to a level greater than the accelerator chamber itself in order to produce the desired flow.

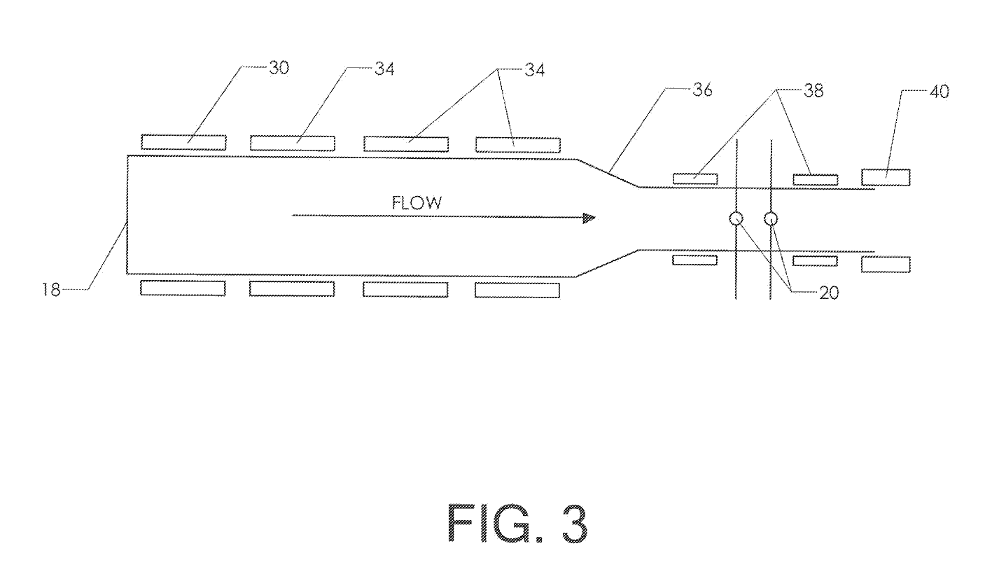

The accelerator chamber 18 includes several stages. FIG. 3 shows accelerator chamber 18 in more detail. Immediately after injection, the fuel mixture is subjected to arc furnace 30. This rapidly heats the mixture and converts it into a gaseous form. Significantly, the heating and acceleration is done without the use of combustion phenomena. The arc furnace may include a high-energy pulsed input of variable frequency. The frequency or frequencies are preferably selected to match the resonance frequency of the fuel constituents as closely as possible. For complex substances like coal, no single natural frequency will exist. In such a case one or more approximations are used to produce the desired resonance. The resonance process assists in breaking the physical and chemical bonds of the fuel stock. The chemical bond energy is liberated as heat, which causes the mixture to expand and accelerate down the length of the chamber.

The fuel mixture accelerates to the right in the orientation shown in FIG. 3. Once the mixture leaves the arc furnace area it is subjected to microwave (or higher frequency) energy for the purpose of further breaking the carbon-carbon bonds within the hydrocarbon chains. One or more microwave generators 34 are used for this purpose. The microwave energy liberates bonding energy and the resulting heat is used to further accelerate the mixture down the accelerator chamber. This process is not to be confused with the process of using microwave energy to break long chain oils into shorter hydrocarbons (such as lighter oils). The inventor is employing the liberation of the bond energy primarily for heating and resulting acceleration down the accelerator chamber.

Sufficient energy is added (or liberated via bond breaking) to heat and accelerate the fuel mixture until a significant percentage can transition to a plasma state. As the fuel stream accelerates toward the right end of accelerator chamber 18 it is subjected to additional microwave energy to accelerate the fuel stream. Microwave generators 34 provide this energy.

Throat 36 may be provided to constrict and accelerate the flow further. One or more target systems 20 are provided in a region referred to as the electron removal area. If a constriction is provided—such as throat 36—the constriction is preferably located just before the flow enters the electron removal area.

The inventor has discovered that a flowing plasma under certain conditions may be highly conductive and easily oriented in the presence of a microwave source. The invention seeks to take advantage of this phenomenon. Additional microwave generators 38 are provided to polarize the plasma according to the orientation of the target systems.

Returning to FIG. 1, the reader will observe that at least one of the target systems 20 is connected to electron removal circuit 22 in the electron removal area. The alignment of the plasma will be “tuned” to maximize the amount of free electrons which may be removed by the electron removal circuit connected to target 20.

The target systems are shown in a very simplified depiction. In reality, it is more appropriate to speak of a fast moving plasma as “interacting with” a target rather than striking it. Once the flow exceeds the local speed of sound, normal and oblique shock waves will form ahead of the target. The system for removing free electrons may need to utilize probes placed at suitable locations within the flow (adjacent to the target) rather than electrically connecting the target itself.

The plasma downstream of the target will have a reduced amount of free electrons. It is also possible to remove even more electrons by encircling this part of the chamber with a MHG (magnetohydrodynamic generator). FIG. 3 shows the placement of MHG 40 just downstream of the two target systems. In this embodiment, a second microwave generator 38 is placed between the target systems 20 and the MHG 40.

FIG. 1 shows the continuation of the process downstream of the target area. Leaving the area of free electron removal, the mixture passes into heat and velocity reduction zone 24. This area may encompass many conventional devices intended to cool and depressurize the mixture—such as a high-ratio expansion nozzle with an encompassing cooling jacket. Other devices include expansion turbines, heat exchangers, and the like.

When a fuel decelerates and cools from a plasma state it normally reforms most of the original constituents. However, under the inventive process, the removal of a large portion of the available bonding electrons prevents the reformation of the original constituents. As an example, the free hydrogen ions will consume many of the remaining free electrons to reform as diatomic hydrogen gas. Likewise, the relative lack of free electrons will cause the alteration of chain lengths in the hydrocarbon chains. Further, the resulting products can be somewhat “adjusted” by the amount of free electrons removed during the plasma phase. In other words, the system might be operated to remove fewer electrons than the target systems and MHG are capable of removing.

Heat and velocity reduction 24 reduces the temperature and velocity to a desired state before the mixture enters refinery 26. The refinery separates the constituents into solids, liquids, and gasses (or in some instances some subset of these three possibilities). The refinery components are conventional and include such things as filters, sedimenters, etc.

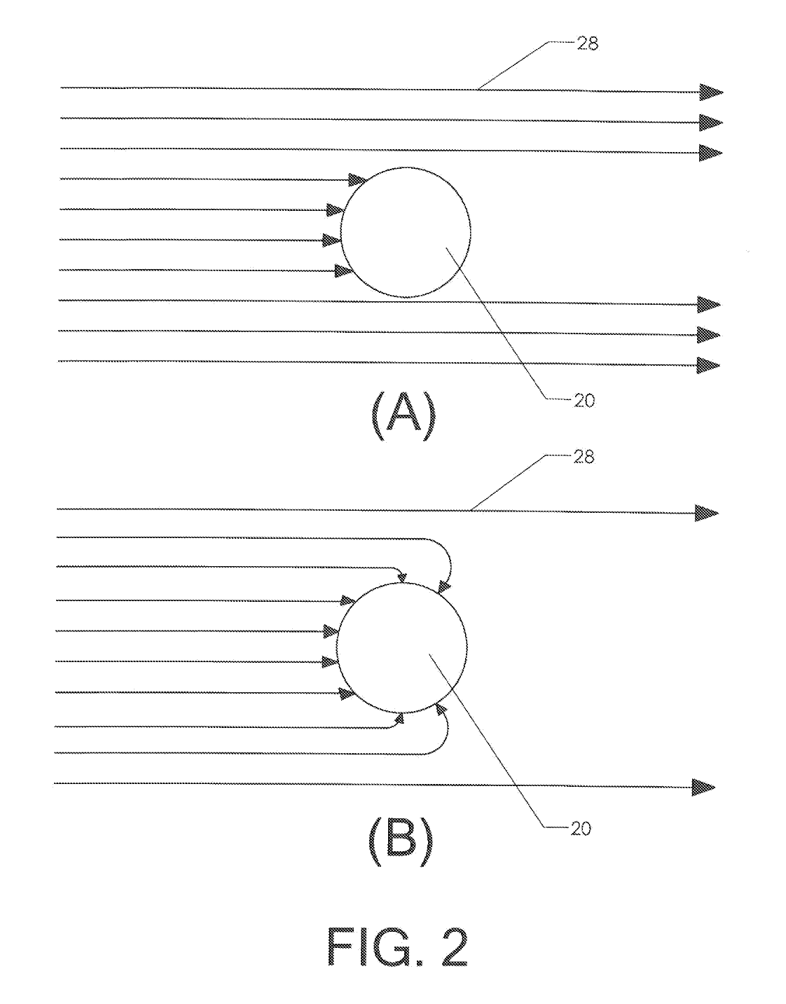

FIG. 2 shows the area of target 20 in greater detail. In FIG. 2(A) plasma flow 28 has been aligned via the addition of the microwave field. In FIG. 2(B) the electron removal circuit has been activated. This causes the streams of plasma flow to bend in toward the target and facilitates the removal of free electrons. Microwave energy in the range of X Band or K Band radar is preferred for this part of the process, but other wavelengths may be used as well.

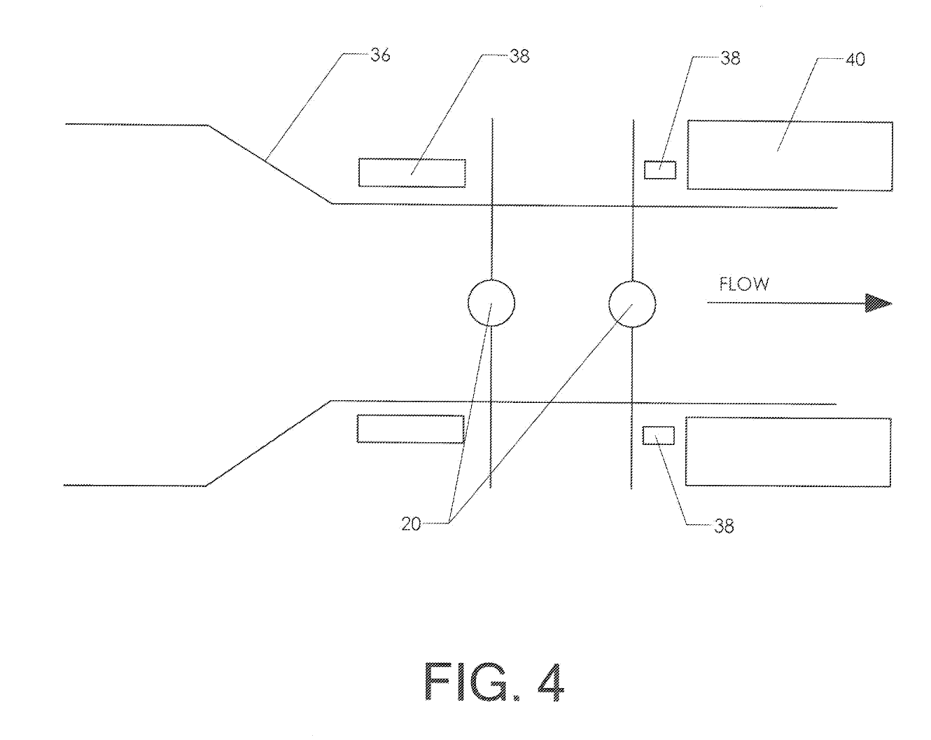

FIG. 4 shows the vicinity of the target system or systems 20. The constriction in the chamber just before the electron removal area may assist in free electron removal. MHG 40 may be added downstream of the target in order to remove additional free electrons. As explained previously, a second microwave generator 38 may be added between the target systems and the MHG.

The fuel transitions from a plasma state to a non-plasma state (“non-plasma state” meaning one or more of a solid, liquid, or gaseous phase of matter) after passing out of the electron removal area.

It may be conventional to think of the acceleration chamber, throat, and other structures as being radially symmetric (such as would be the case for a rocket nozzle). However, this need not be the case for every embodiment. A rectangular cross section analogous to the geometry of a wave guide used in microwave antennas may be used. Another analogous geometry is that used for supersonic combustion ramjets. These resemble wave guides, but often allow for a portion of the geometry to be selectively altered. This selective alteration allows the flow characteristics to be changed, which may provide advantages.

The reader will thereby appreciate that the inventive process alters a hydrocarbon-containing fuel via the use of an intermediate plasma state and the removal of free electrons. Significantly, no combustion process is employed and the production of unwanted greenhouse gasses is thereby eliminated or at least greatly reduced.

The preceding description contains significant detail regarding the novel aspects of the present invention. It is should not be construed, however, as limiting the scope of the invention but rather as providing illustrations of the preferred embodiments of the invention. For example, although the use of a constricting throat area has been illustrated, this need not be present in every embodiment of the invention. Thus, the scope of the invention should be fixed by the claims presented, rather than by the examples given.

Having described my invention, I claim:

1. A method for modifying a molecular substance by altering the molecular chain length, comprising:
a. providing said molecular substance;
b. injecting said molecular substance into an accelerator chamber;
c. subjecting said molecular substance to electric pulses while said molecular substance is in said accelerator chamber;
d. subjecting said molecular substance to microwave energy sufficient to accelerate said substance down said accelerator chamber and to heat said substance sufficiently to ionize said substance and form a fast-flowing plasma;
e. providing an electron removal area connected to said accelerator chamber;
f. providing a target located in said electron removal area, wherein said target forms part of an electron removal circuit,
g. directing said fast-flowing plasma through said electron removal area so that said fast-flowing plasma interacts with said target;
h. using microwave energy in the vicinity of said electron removal area to polarize said fast-flowing plasma as it interacts with said target;
i. removing a portion of free electrons within said plasma using said electron removal circuit;
j. after said portion of said free electrons are removed, decelerating and cooling said plasma so that it transitions from said plasma state to a non-plasma state in the absence of said removed electrons, thereby altering the makeup of said molecular substance in order to form an altered molecular substance; and
k. collecting said altered molecular substance.

2. A method for modifying a molecular substance as recited in claim 1, further comprising providing said electron removal area with a microwave generator to saturate said plasma flow in said electron removal area.

3. A method for modifying a molecular substance as recited in claim 2, further comprising providing a throat just prior to said electron removal area.

4. A method for modifying a molecular substance as recited in claim 1, wherein said step of collecting said altered molecular substance comprises refining the products exiting said decelerating and cooling step in order to separate and recover solids, liquids, and gasses.

5. A method for modifying a molecular substance as recited in claim 1 wherein said electric pulses are varied according to a frequency and wherein said frequency is matched to a resonant frequency of said molecular substance.

6. A method for modifying a molecular substance into an altered molecular substance, comprising:
a. providing said molecular substance;
b. providing a pressurized accelerator chamber which is sealed to prevent the introduction of an external oxidizer;
c. injecting said molecular substance into said accelerator chamber without the introduction of an external oxidizer;
d. subjecting said molecular substance to electric pulses while said molecular substance is in said accelerator chamber;
e. subjecting said molecular substance to microwave energy sufficient to accelerate said substance down said accelerator chamber and to heat said substance sufficiently to ionize said substance and form a fast-flowing plasma;
f. providing an electron removal area connected to said accelerator chamber;
g. providing a target located in said electron removal area, wherein said target forms part of an electron removal circuit,
h. directing said fast-flowing plasma through said electron removal area so that said plasma interacts with said target;
i. using microwave energy in the vicinity of said electron removal area to polarize said fast-flowing plasma as it interacts with said target;
j. removing a portion of free electrons within said plasma using said electron removal circuit;
k. after said portion of said free electrons are removed, decelerating and cooling said plasma so that it transitions from said plasma state to a non-plasma state in the absence of said removed electrons, thereby altering the makeup of said molecular substance in order to form an altered molecular substance; and
l. collecting said altered molecular substance.

7. A method for modifying a molecular substance as recited in claim 6, further comprising providing said electron removal area with a microwave generator to saturate said plasma flow in said electron removal area.

8. A method for modifying a molecular substance as recited in claim 7, further comprising providing an additional target in said electron removal area.

9. A method for modifying a molecular substance as recited in claim 6, wherein said step of collecting said altered molecular substance comprises refining the products exiting said decelerating and cooling step in order to separate and recover solids, liquids, and gasses.

10. A method for modifying a molecular substance as recited in claim 6 wherein said electric pulses are varied according to a frequency and wherein said frequency is matched to a resonant frequency of said molecular substance.
